(19) United States
(12) Patent Application Publication
(10) Pub. No.: US 2025/0147142 A1
(43) Pub. Date: May 8, 2025

(54) METHOD FOR LOCATING AN IDENTIFICATION TRANSMITTER OF A MOTOR VEHICLE

(71) Applicant: MERCEDES-BENZ GROUP AG, Stuttgart (DE)

(72) Inventors: Matthias REINHARDT, Sindelfingen (DE); Konrad BETZ, Stuttgart (DE); Marco LEICHT, Neuhausen (DE); Jochen SENDLER, Stuttgart (DE)

(21) Appl. No.: 18/682,577

(22) PCT Filed: Jul. 11, 2022
(86) PCT No.: PCT/EP2022/069233

§ 371 Date: Feb. 9, 2024

(30) Foreign Application Priority Data
Aug. 10, 2021 (DE) 10 2021 004 100.3

(51) Int. Cl. G01S 5/02

(52) U.S. Cl. CPC G01S 5/0273; G01S 5/0284

(57) ABSTRACT

A method for locating an identification transmitter of a motor vehicle using a functional device of the motor vehicle involves the identification transmitter transmitting a location signal and the functional device receiving the original location signal and a reflected location signal. The functional device respectively determines a distance to the identification transmitter from the location signals. The functional device checks whether the reflected location signal corresponds to a short-range reflection of the original location signal. Depending on the latter, the functional device locates the identification transmitter.

### BACKGROUND AND SUMMARY OF THE INVENTION

Exemplary embodiments of the invention relate to a method for locating an identification transmitter of a motor vehicle, a functional device of the motor vehicle for carrying out the method, and the motor vehicle having the functional device.

It is already known from DE 10 2018 005763 A1 to locate a key of a motor vehicle with a functional device. For this purpose, the key sends an LF location signal (LF: Low Frequency), which is received by at least two LF receiving units of the motor vehicle at a distance from each other. The LF location signal is a low-frequency signal having a frequency below 150 kHz. The functional device then evaluates the distance of the key to the respective LF receiving unit using the LF location signal, and determines the position of the key in a 2D coordinate system. A keyless go functionality can thus be implemented in the motor vehicle.

In future, the keyless go functionality should also be implemented in the motor vehicle with an active identification transmitter, e.g., in the form of a smartphone. The identification transmitter contains the authorization data required for the access system of the vehicle and for the driving authorization system of the vehicle in a storage region. This is known as a digital key. For this purpose, the functional device should be able to locate the identification transmitter in a comparable manner to the key. Depending on the position of the identification transmitter, a keyless go functionality can then be implemented in the motor vehicle—just like with the key. Unlike the key, the smartphone or the active identification transmitter has no LF radio unit, and it is not possible to locate the smartphone via the LF receiving units of the motor vehicle. A UWB radio unit of the smartphone or of the identification transmitter (UWB: Ultra Wide Band) for transmitting a UWB location signal and UWB receiving units of the motor vehicle should be used to locate the smartphone or the active identification transmitter. The UWB method is a transmission method using a bandwidth of at least 500 MHZ.

The motor vehicle disadvantageously comprises fewer UWB receiving units than LF receiving units. Two UWB receiving units are thus usually arranged at the front and two UWB receiving units are arranged at the rear of the motor vehicle. If, for example, the smartphone is in the rear boot or in the frunk or in the front boot of the motor vehicle, its UWB location signal is received only by the rear UWB receiving units or only by the front UWB receiving units, and thus the smartphone cannot always be unambiguously located.

Exemplary embodiments of the invention are directed to an improved, or at least an alternative method, a corresponding functional device for carrying out the method and a motor vehicle having the functional device, in which the described disadvantages are overcome.

A method is provided for locating an active identification transmitter of a motor vehicle by means of a functional device of the motor vehicle. In the method, the identification transmitter transmits a location signal and the functional device receives an original location signal of the identification transmitter and at least one reflected location signal of the identification transmitter. The functional device respectively determines a distance to the identification transmitter from the received original location signal and from the at least one received reflected location signal. The functional device then checks whether the at least one reflected location signal corresponds to a short-range reflection of the original location signal using the determined distances. The functional device locates the identification transmitter depending on whether the at least one reflected location signal corresponds or does not correspond to a short-range reflection of the original location signal. Locating in this case means determining the position of the identification transmitter in relation to the motor vehicle.

In the context of the present invention, the original location signal is a location signal of the identification transmitter, which reaches the functional device from the identification transmitter via a direct path. In the context of the present invention, the reflected location signal is a location signal of the identification transmitter, which is reflected on an object at least once on its way from the identification transmitter to the functional device.

The following consideration is used in the method according to the invention. The location signal of the identification transmitter propagates on a shorter propagation path, and usually on at least one further, longer propagation path. The shorter propagation path results from a direct connection between the identification transmitter and the radio device. The longer propagation path results from a reflection of the location signal on a nearby object. If the identification transmitter is in the exterior, then the nearby object can, for example, be a wall or the ground. The reflected location signal then covers a significantly greater distance than the original location signal. The distance of the identification transmitter, which is determined using the reflected location signal, is thus significantly longer than the distance of the identification transmitter, which is determined from the original location signal. This can be referred to as a long-range reflection of the location signal. If the identification transmitter is in the motor vehicle—in particular in the rear boot or in the frunk or in the front boot—then the nearby object can, for example, be a boot wall. The reflected location signal then covers a distance that is similar to the distance of the original location signal or has no significant deviation. The distance of the identification transmitter, which is determined using the reflected location signal, is thus similar or not significantly larger than the distance of the identification transmitter, which is determined from the original location signal. This can be referred to as a short-range reflection of the location signal.

A short-range reflection of the location signal may be present if the distance assigned to the reflected location signal and the distance assigned to the original location signal differ by a factor that does not exceed a pre-determined threshold factor and/or by an amount which does not exceed a pre-determined threshold amount. A long-range reflection of the original location signal may be present if the distance assigned to the reflected location signal and the distance assigned to the original location signal differ by a factor that exceeds a pre-determined threshold factor and/or by an amount which exceeds a pre-determined threshold amount.

The functional device can advantageously have at least one receiving unit for receiving location signals of the identification transmitter and an evaluation unit for evaluating the received location signals of the identification transmitter. In the method according to the invention, the functional device can check whether the reflected location signal is reflected at short-range or at long-range, and thus determine whether the identification transmitter is in the exterior or in the motor vehicle. The identification transmitter can be unambiguously located as soon as the original location signal and the at least one reflected location signal can be received by a single receiving unit of the functional device. No further receiving units are thus required in the motor vehicle, and costs, installation space and weight of the functional device or of the motor vehicle can be reduced. The method is thus simplified in comparison with conventional solutions, and the identification transmitter can be located more quickly or without worsening reaction times. The energy requirement both for operating the identification transmitter and for operating the functional device is additionally reduced by the method according to the invention.

The functional device can locate the identification transmitter as being in the motor vehicle if the at least one reflected location signal corresponds to a short-range reflection of the location signal. If the at least one reflected location signal does not correspond to a short-range reflection of the original location signal, then the functional device can locate the identification transmitter as being outside of the motor vehicle. In the method, the identification transmitter can thus be unambiguously located, and a keyless go functionality can be implemented in the motor vehicle in a simplified manner.

The functional device can compare the determined distances with one another and, on that basis, determine whether the at least one reflected location signal corresponds to a short-range reflection of the location signal. When comparing one distance with the other distance, the functional device can determine the at least one reflected location signal to be a short-range reflection of the location signal if the two distances differ by a factor that does not exceed a pre-determined threshold factor or by an amount which does not exceed a pre-determined threshold amount.

The functional device can also determine the number of short-range reflections of the location signal. If the number of short-range reflections of the location signal exceeds a pre-determined threshold number, then the functional device can locate the identification transmitter as being in the motor vehicle. If the number of short-range reflections of the location signal does not exceed the pre-determined threshold number, then the functional device can locate the identification transmitter as being outside of the motor vehicle. The pre-determined threshold number can, for example, be equal to or greater than one.

In an advantageous development of the method, it can be provided that the identification transmitter transmits the UWB location signal. The functional device can then receive and evaluate the original UWB location signal of the identification transmitter and the at least one reflected OWB location signal of the identification transmitter. The identification transmitter can, for example, be a so-called digital key or a smartphone having a UWB radio unit. A keyless go functionality can thus also be implemented in the motor vehicle with a smartphone.

The invention also relates to a functional device of a motor vehicle for locating an identification transmitter of the motor vehicle. The functional device has at least one receiving unit for receiving location signals of the identification transmitter and an evaluation unit for evaluating the received location signals of the identification transmitter. The functional device is designed to carry out the method described above.

As already described above, the at least one receiving unit of the functional device can be designed to receive the UWB location signals of the identification transmitter, and the evaluation unit of the functional device can be designed to evaluate the received UWB location signals of the identification transmitter. In this case, the identification transmitter can be a smartphone having a UWB radio unit, such that no keyless go functionality can be implemented with the smartphone in the motor vehicle.

The invention also relates to a motor vehicle having an identification transmitter for transmitting a location signal. The motor vehicle has the above-described functional device for locating the identification transmitter. As has already been described above, the functional device has at least one receiving unit for receiving location signals of the identification transmitter and an evaluation unit for evaluating the received location signals of the identification transmitter. The at least one receiving unit of the functional device is fixed to the outside of the motor vehicle.

As already explained above, the identification transmitter can be a smartphone having a UWB radio unit for transmitting a UWB location signal. The receiving unit can correspondingly be designed to receive the UWB location signals of the identification transmitter and the evaluation unit can be designed to evaluate the received UWB location signals of the identification transmitter.

It can additionally be provided that the functional device has at least four, preferably exactly four UWB receiving units. The at least four, preferably exactly four UWB receiving units are then fixed to the motor vehicle on the outside of the motor vehicle, respectively next to a front headlight at the front and respectively next to a rear light at the back. It is, in particular, advantageous that the identification transmitter can also even be unambiguously located using one of the at least four or exactly four UWB receiving units, in the rear boot or in the frunk or in the front boot with the method described above.

Further important features and advantages of the invention result from the sub-claims, from the drawings and from the associated description of figures with reference to the drawings.

Naturally, the features specified above and which are still to be explained in the following can be used not only in the respectively specified combination, but also in other combinations or in isolation, without leaving the scope of the present invention.

Preferred exemplary embodiments of the invention are represented in the drawings and are explained in more detail in the following description, wherein identical reference numerals relate to identical or similar or functionally identical components.

### BRIEF DESCRIPTION OF THE DRAWING FIGURES

Here, respectively schematically:

FIG. 1 shows a partial view of a conventional motor vehicle having a conventional functional device for locating an identification transmitter of the motor vehicle;

FIG. 2 shows a partial view of a motor vehicle according to the invention having a functional device according to the invention for locating an identification transmitter of the motor vehicle.

### DETAILED DESCRIPTION

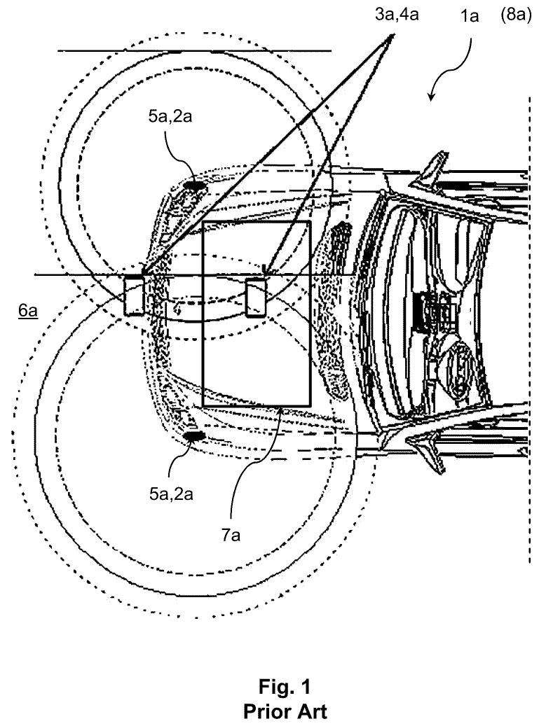

FIG. 1 shows a partial view of a conventional motor vehicle 1a having a conventional functional device 2a for locating an identification transmitter 3a of the motor vehicle 1a. The identification transmitter is here depicted as a smartphone 4a for transmitting a UWB location signal, and the functional device 2a has two front UWB receiving units 5a and two rear UWB receiving units (not visible here). The functional device 2a can locate the smartphone 4a with a conventional method 8a by determining distances of the smartphone 4a to the UWB receiving units 5a, and from the latter the geometric position of the smartphone 4a. The smartphone 4a is shown in FIG. 1 in two—exemplary—positions: in the exterior 6a of the motor vehicle 1a and in a frunk 7a of the motor vehicle 1a. In both positions, the UWB location signal of the smartphone 4a can only be received by the front UWB receiving units 5a. In the conventional method 8a, however, the functional device 2a cannot differentiate the positions of the smartphone 4a shown, because the distances between the smartphone 4a and the UWB receiving units 5a are identical in both positions. A further UWB receiving unit 5a is necessary to locate the smartphone 4a with certainty.

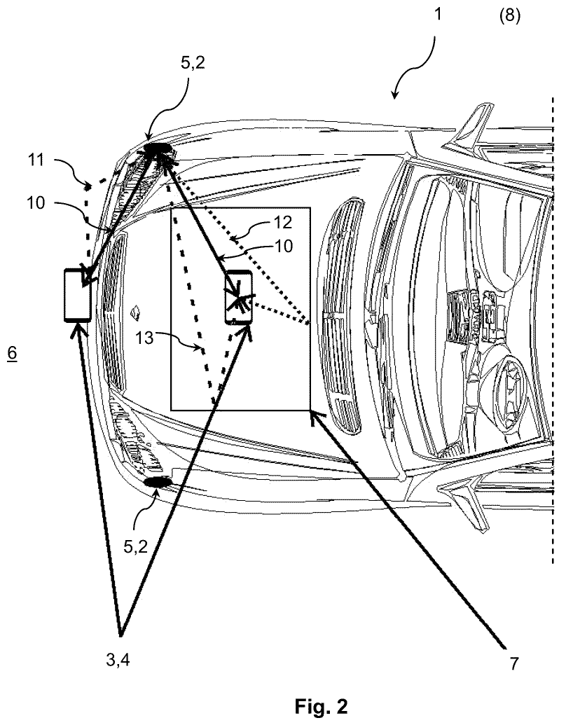

FIG. 2 shows a partial view of a motor vehicle 1 according to the invention having a functional device 2 according to the invention for locating an identification transmitter 3 of the motor vehicle 1. Here too, the identification transmitter 3 is depicted as a smartphone 4 for transmitting a UWB location signal, and the functional device 2 has two front UWB receiving units 5 and two rear UWB receiving units (not visible here). The smartphone 4 is shown in FIG. 2 in two positions: in the exterior 6 of the motor vehicle 1 and in a frunk 7 of the motor vehicle 1. These positions correspond to the exemplary positions shown in FIG. 1. With the method 8 according to the invention, the smartphone 4 can now be unambiguously located without further UWB receiving units 5.

If the smartphone 4 is in the exterior 6, then the UWB receiving unit 5 receives an original UWB location signal 10 and a reflected UWB location signal 11 of the smartphone 4. The original UWB location signal 10 reaches the UWB receiving unit 5 from the smartphone 4 via the direct path. The reflected UWB location signal 11 is reflected once—here, as an example—on the ground 12 on its way from the smartphone 4 to the UWB receiving unit 5. The reflected UWB location signal 11 is depicted here with dashed lines for better differentiation. An evaluation unit of the functional device (not shown here) can then respectively determine a distance to the smartphone 4 from the received UWB location signals 10 and 11, and compare these distances. The two distances also differ significantly, because the reflected UWB location signal 11 covers a significantly larger distance than the original UWB location signal 10. The evaluation unit then evaluates the received reflected UWB location signal 11 as not being a short-range reflection of the original UWB location signal 10, and locates the smartphone as not being in the motor vehicle 1.

If the smartphone 4 is in the frunk 7, then the UWB receiving unit 5 receives the original UWB location signal 10 and two reflected UWB location signals 12 and 13. The reflected UWB location signals 12 and 13 are depicted here with dashed lines for better differentiation. The original UWB location signal 10 reaches the UWB receiving unit 5 from the smartphone 4 via the direct path. The reflected UWB location signals 12 and 13 are reflected on walls of the frunk 12 on their way from the smartphone 4 to the UWB receiving unit 5. The evaluation unit of the functional device 2 can now respectively determine a distance to the smartphone 4 from the received UWB location signals 10, 12 and 13, and compare these distances with one another. However, the distance covered is almost identical, or at least not significantly different, in the case of all UWB location signals 10, 12 and 13. Accordingly, the distances also do not significantly differ from each other. The evaluation unit now respectively evaluates the reflected UWB location signals 12 and 13 as being a short-range reflection of the original UWB location signal 10, and locates the smartphone as being in the motor vehicle 1.

It can certainly be the case that the reflected path 11 has a short distance to the original path, and thus corresponds to a short-range reflection (for example, a reflection over the ground may not mean a particularly long additional path). In the frunk/in the interior of the vehicle, however, we expect further short-range reflections. In the example, 13 would be a short distance from 12. In the exterior, it can be assumed that the further reflection paths are over neighboring objects, e.g., a wall, and thus are not short-range.

With the method 8 according to the invention, the smartphone 4 can be unambiguously located by means of a single UWB receiving unit 5 of the functional device 2. An additional UWB receiving unit thus becomes unnecessary. A keyless go functionality can be implemented in the motor vehicle 1 with the smartphone 4 without further costs, additional installation space and additional weight.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for locating an identification transmitter of a motor vehicle using a functional device of the motor vehicle, the method comprising:
transmitting, by the identification transmitter, a location signal;
receiving, by the functional device, an original location signal of the location signal transmitted by the identification transmitter and at least one received reflected location signal of the location signal transmitted by the identification transmitter;
respectively determining, by the functional device, a distance to the identification transmitter using the received original location signal and the at least one received reflected location signal;
checking, by the functional device, whether the received at least one reflected location signal corresponds to a short-range reflection of the transmitted location signal using the distances of the identification transmitter determined using the received original location signal and the received at least one received reflected location signal; and
locating, by the functional device, the identification transmitter depending on whether or not the at least one received reflected location signal corresponds to a short-range reflection of the transmitted location signal.

12. The method of claim 11, wherein the functional device locates the identification transmitter as being
in the motor vehicle if the at least one received reflected location signal corresponds to a short-range reflection of the transmitted location signal; and
outside of the motor vehicle if the at least one received reflected location signal does not correspond to a short-range reflection of the transmitted location signal.

13. The method of claim 11, wherein the functional device compares the the distances of the identification transmitter determined using the received original location signal and the received at least one received reflected location signal with one another, and wherein, based on the comparison, the functional device determines whether the at least one received reflected location signal corresponds to a short-range reflection of the transmitted location signal.

14. The method of claim 11, wherein the functional device
determines a number of received short-range reflections of the transmitted location signal,
locates the identification transmitter as being in the motor vehicle if the determined number of received short-range reflections of the transmitted location signal exceeds a pre-determined threshold number, and
locates the identification transmitter as being outside of the motor vehicle if the number of determined short-range reflections of the transmitted location signal does not exceed the pre-determined threshold number.

15. The method of claim 11, wherein transmitted location signal is an ultra-wideband (UWB) location signal.

16. A functional device of a motor vehicle for locating an identification transmitter of the motor vehicle, the functional device comprising:
at least one receiving unit configured to receive an original location signal of a location signal transmitted by the identification transmitter and at least one received reflected location signal of the location signal transmitted by the identification transmitter; and
an evaluation unit configured to evaluate the received location signals by
respectively determining a distance to the identification transmitter using the received original location signal and the at least one received reflected location signal;
checking whether the received at least one reflected location signal corresponds to a short-range reflection of the transmitted location signal using the distances of the identification transmitter determined using the received original location signal and the received at least one received reflected location signal; and
locating the identification transmitter depending on whether or not the at least one received reflected location signal corresponds to a short-range reflection of the transmitted location signal.

17. The functional device of claim 16, wherein the at least one receiving unit of the functional device is configured to receive the transmitted location signal as an ultra-wideband (UWB) location signal.

18. A motor vehicle, comprising:
an identification transmitter configured to transmit a location signal; and
a functional device configured to locate the identification transmitter, wherein the functional device comprises
at least one receiving unit configured to receive an original location signal of a location signal transmitted by the identification transmitter and at least one received reflected location signal of the location signal transmitted by the identification transmitter; and
an evaluation unit configured to evaluate the received location signals by respectively determining a distance to the identification transmitter using the received original location signal and the at least one received reflected location signal;
checking whether the received at least one reflected location signal corresponds to a short-range reflection of the transmitted location signal using the distances of the identification transmitter determined using the received original location signal and the received at least one received reflected location signal; and
locating the identification transmitter depending on whether or not the at least one received reflected location signal corresponds to a short-range reflection of the transmitted location signal,
wherein the at least one receiving unit is fixed to an outside of the motor vehicle.

19. The motor vehicle of claim 18, wherein
the identification transmitter is a smartphone having an ultra-wideband UWB radio unit configured to transmit the location signal as an UWB location signal, and
the at least one receiving unit is configured to receive the transmitted UWB location signal.

20. The motor vehicle of claim 19, wherein
the functional device has exactly four UWB receiving units that are fixed to the motor vehicle on the outside of the motor vehicle, respectively next to a front headlight at a front of the vehicle and respectively next to a rear light at a back of the vehicle.
